(19) United States
(12) Patent Application Publication
(10) Pub. No.: US 2025/0382732 A1
(43) Pub. Date: Dec. 18, 2025

(54) Thermoplastic Elastomer-Based Fabric

(71) Applicant: Celanese Polymers Holding, Inc., Wilmington, DE (US)

(72) Inventor: Carmen A. Covelli, Chadds Ford, PA (US)

(21) Appl. No.: 19/234,479

(22) Filed: Jun. 11, 2025

Related U.S. Application Data
(60) Provisional application No. 63/658,894, filed on Jun. 12, 2024.

(51) Int. Cl. D04B 1/18; C08G 63/183; C08G 63/672; D03D 15/283

(52) U.S. Cl. CPC D04B 1/18; C08G 63/183; C08G 63/672; D03D 15/283; D10B 2331/04; D10B 2401/06

(57) ABSTRACT

A continuous thermoplastic elastomer-based fabric is disclosed. The fabric comprises a first fabric section and a second fabric section. The first fabric section comprises a plurality of fibers comprising a first fiber comprising a fiber forming material and a second fiber comprising a thermoplastic elastomer wherein the fiber forming material has a melting temperature or a degradation temperature higher than a melting temperature of the thermoplastic elastomer. The second fabric section comprises the first fiber extending from the first fabric section wherein the first fiber is at least partially coated with the thermoplastic elastomer present in the second fabric section. The second fabric section has a higher tensile modulus than the first fabric section.

### RELATED APPLICATION

The present application is based upon and claims priority to U.S. Provisional Patent Application Ser. No. 63/658,894, having a filing date of Jun. 12, 2024, which is incorporated herein by reference.

### BACKGROUND

Engineering thermoplastics are often used in numerous and diverse applications. For instance, polyesters and thermoplastic elastomers, such as thermoplastic copolyester elastomers, are used to produce all different types of articles, including apparel and garments, due to their properties and processing capabilities. Depending on the particular application, even for particular articles such as apparel and garments, it may be desired to have a fabric including certain properties. For instance, it may be desired to have different properties for a particular outerwear article than a particular garment article, such as shapewear. Even more particularly, within such respective article, it may be desired to have different properties, such as stretch/stiffness properties, within respective sections of such article. Currently, such selective placement of properties, or selective power placement, can be achieved by overlying fabric, film, or nowovens, printing dispersions, or laminating at desired areas or by connecting different pieces of fabric. As a result, manufacturing such articles typically requires additional processing steps which may be complex and/or costly.

As such, a need currently exists for providing an improved fabric and resulting article that can provide desired properties in selective areas.

### SUMMARY OF THE DISCLOSURE

In accordance with one embodiment of the present disclosure, a continuous thermoplastic elastomer-based fabric is disclosed. The fabric comprises a first fabric section and a second fabric section. The first fabric section comprises a plurality of fibers comprising a first fiber comprising a fiber-forming material and a second fiber comprising a thermoplastic elastomer wherein the fiber-forming material has a melting temperature or a degradation temperature higher than a melting temperature of the thermoplastic elastomer. The second fabric section comprises the first fiber extending from the first fabric section wherein the first fiber is at least partially coated with the thermoplastic elastomer present in the second fabric section. The second fabric section has a higher tensile modulus than the first fabric section.

In accordance with another embodiment of the present disclosure, a method of making a continuous thermoplastic elastomer-based fabric is disclosed. The method comprises providing a fabric comprising a first fabric section and a second fabric section. The first fabric section comprises a plurality of fibers comprising a fiber-forming material and a second fiber comprising a thermoplastic elastomer wherein the fiber-forming material has a melting temperature or a degradation temperature higher than a melting temperature of the thermoplastic elastomer. The second fabric section comprises the first fiber extending from the first fabric section and the second fiber extending from the first fabric section. The method further comprises subjecting the second fabric section to a temperature equal to or greater than the melting temperature of the thermoplastic elastomer.

Other features and aspects of the present disclosure are set forth in greater detail below.

### BRIEF DESCRIPTION OF THE DRAWINGS

A full and enabling disclosure of the present disclosure is set forth more particularly in the remainder of the specification, including reference to the accompanying figures, in which:

FIGS. 1A-1C provide cyclic testing data in the machine direction of the samples of Example 1.

FIGS. 2A-2C provide cyclic testing data in the cross-machine direction of the samples of Example 1.

FIGS. 3A-3C provide scanning electron microscopy images of the samples of Example 1.

FIG. 4 illustrates a knit structure in accordance with an embodiment of the present disclosure.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a thermoplastic elastomer-based, such as a thermoplastic copolyester elastomer-based, fabric. The fabric includes multiple sections having different mechanical properties. In particular, the fabric includes at least a first fabric section and a second fabric section, each having one or more different mechanical properties. In addition, the form of the thermoplastic elastomer may be different as further defined herein in each of the respective sections in order to attain such different properties.

Conventionally, fabrics having respective sections with different properties have been made using various techniques. For instance, this may include overlying fabric or film at desired areas of a fabric. In addition or alternatively, it may include connecting different pieces of fabric using traditional means for joining two sections of fabric, such as stitching, sewing, gluing, etc. Meanwhile, the present inventor has discovered a fabric and process that does not require such techniques in order to provide a fabric and resulting article with such respective sections having different properties.

In this regard, the present inventor has discovered a fabric and resulting article with some degree of continuity between a respective first fabric section and a second fabric section. In particular, as defined herein, the first fabric section and the second fabric section are continuous. For instance, the first fabric section comprises a plurality of fibers comprising a first fiber comprising a fiber-forming material and a second fiber comprising a thermoplastic elastomer, such as a thermoplastic copolyester elastomer, and the second fabric section comprises the first fiber extending from the first fabric section wherein the first fiber is at least partially coated with the thermoplastic elastomer, such as the thermoplastic copolyester elastomer. Accordingly, the first fiber extends from the first fabric section to the second fabric section. As a result, such sections are continuous. In this regard, such first fiber is not stitched, sewed, glued, overlayed, etc. between such respective sections. Similarly, such fabric sections are not combined by stitching, sewing, gluing, or using overlays.

Furthermore, due to processing as defined herein, the second fiber comprising the thermoplastic elastomer, such as the thermoplastic copolyester elastomer, has melted in the second fabric section such that it at least partially coats the first fiber. Meanwhile, the second fiber is still present in the first fabric section. Accordingly, both the first fabric section and the second fabric section contain the thermoplastic elastomer, such as the thermoplastic copolyester elastomer, albeit in different forms. However, prior to the processing at the elevated temperatures as disclosed herein, such second fiber also extended from the first fabric section to the second fabric section. In this regard, such second fiber was also present in the second fabric section in a fiber form prior to the processing at elevated temperatures.

The present inventor has discovered that by providing such a fabric, a resulting article may have desired properties and characteristics in selective areas. For instance, the fabric and resulting article may be tailored to provide desired stretch/stiffness properties, particularly in selective areas. In addition, such desired properties may be obtained by minimizing processing steps typically required in order to obtain an article having such properties. For instance, such typical processes may include stitching, sewing, gluing, overlaying, etc. of two pieces of fabric in order to obtain desired properties at desired locations of the fabric.

Meanwhile, such stretch/stiffness properties may correspond to the tensile modulus. Without intending to be limited, a higher tensile modulus may provide a fabric that may resist movement. In this regard, the first fabric section may have a lower tensile modulus than the second fabric section. For instance, the tensile modulus of the second fabric section may be 1% or more, such as 3% or more, such as 5% or more, such as 10% or more, such as 20% or more, such as 30% or more, such as 40% or more, such as 50% or more, such as 60% or more, such as 70% or more, such as 80% or more, such as 90% or more, such as 100% or more, such as 125% or more, such as 150% or more, such as 175% or more, such as 200% or more, such as 225% or more, such as 250% or more, such as 275% or more, such as 300% or more, such as 325% or more, such as 350% or more, such as 375% or more, such as 400% or more, such as 425% or more, such as 450% or more, such as 475% or more, such as 500% or more, such as 550% or more, such as 600% or more, such as 650% or more, such as 700% or more, such as 750% or more, such as 800% or more, such as 850% or more, such as 900% or more, such as 950% or more, such as 1000% or more, such as 1100% or more, such as 1200% or more, such as 1300% or more, such as 1400% or more, such as 1500% or more the tensile modulus of the first fabric section. The tensile modulus of the second fabric section may be 3000% or less, such as 2800% or less, such as 2600% or less, such as 2400% or less, such as 2200% or less, such as 2000% or less, such as 1800% or less, such as 1600% or less, such as 1400% or less, such as 1200% or less, such as 1000% or less, such as 900% or less, such as 800% or less, such as 700% or less, such as 600% or less, such as 500% or less, such as 450% or less, such as 400% or less, such as 350% or less, such as 300% or less, such as 250% or less, such as 200% or less, such as 180% or less, such as 160% or less, such as 140% or less, such as 120% or less, such as 100% or less the tensile modulus of the first fabric section. In general, the tensile modulus may be determined at a temperature of 23° C. in accordance with ASTM D4964-96 (2020).

Further, the ratio of the tensile modulus of the first fabric section to the tensile modulus of the second fabric section may be less than 1. For instance, the ratio may be 0.0001 or more, such as 0.0005 or more, such as 0.001 or more, such as 0.005 or more, such as 0.01 or more, such as 0.05 or more, such as 0.1 or more, such as 0.2 or more, such as 0.3 or more, such as 0.4 or more, such as 0.5 or more, such as 0.6 or more. The ratio may be less than 1, such as 0.9 or less, such as 0.8 or less, such as 0.7 or less, such as 0.6 or less, such as 0.5 or less, such as 0.4 or less, such as 0.3 or less, such as 0.25 or less, such as 0.2 or less, such as 0.15 or less, such as 0.1 or less, such as 0.08 or less, such as 0.06 or less, such as 0.04 or less, such as 0.03 or less, such as 0.02 or less, such as 0.01 or less.

In addition, the first fabric section may have a lower elongation than the second fabric section. In general, the elongation may be determined at a temperature of 23° C. in accordance with ASTM D4964-96 (2020).

Furthermore, due to the application of heat and subsequent melting of the thermoplastic elastomer, such as the thermoplastic copolyester elastomer, within the second fabric section, the fabric weight within the first fabric section may be different from that of the second fabric section. In this regard, the fabric weight of a respective section may be 0.5 oz/yd² or more, such as 1 oz/yd² or more, such as 1.5 oz/yd² or more, such as 2 oz/yd² or more, such as 2.5 oz/yd² or more, such as 3 oz/yd² or more, such as 4 oz/yd² or more, such as 5 oz/yd² or more, such as 6 oz/yd² or more, such as 7 oz/yd² or more, such as 8 oz/yd² or more, such as 9 oz/yd² or more, such as 10 oz/yd² or more, such as 11 oz/yd² or more, such as 12 oz/yd² or more, such as 13 oz/yd² or more, such as 14 oz/yd² or more, such as 15 oz/yd² or more. The fabric weight of a respective section may be 30 oz/yd² or less, such as 26 oz/yd² or less, such as 22 oz/yd² or less, such as 20 oz/yd² or less, such as 18 oz/yd² or less, such as 16 oz/yd² or less, such as 14 oz/yd² or less, such as 12 oz/yd² or less, such as 10 oz/yd² or less, such as 9 oz/yd² or less, such as 8 oz/yd² or less, such as 7 oz/yd² or less, such as 6 oz/yd² or less, such as 5 oz/yd² or less, such as 4 oz/yd² or less, such as 3 oz/yd² or less. Such fabric weight may be the final fabric weight of a respective section.

In addition, in one embodiment, the second fabric section may have a lower fabric weight than the first fabric section. Without intending to be limited by theory, the melting of the thermoplastic elastomer, such as the thermoplastic copolyester elastomer, may allow it to extend out as it is no longer present in fiber form. In this regard, the ratio of the fabric weight of the first fabric section to the fabric weight of the second fabric section may be greater than 1 in certain embodiments.

Various embodiments of the present disclosure will now be described in more detail.

### I. Thermoplastic Elastomer Composition

As indicated herein, at least some of the fibers of the plurality of fibers of the fabric, particularly a respective fabric section, are made from a thermoplastic elastomer, such as a thermoplastic copolyester elastomer. In one embodiment, such fibers may be made from a thermoplastic elastomer composition, such as a thermoplastic copolyester elastomer composition, comprising a thermoplastic elastomer, such as a thermoplastic copolyester elastomer. In addition, the thermoplastic elastomer composition, such as the thermoplastic copolyester elastomer composition may also include other additives as generally known in the art.

### A. Thermoplastic Elastomer

As indicated above, the thermoplastic elastomer composition includes a thermoplastic elastomer. For instance, the thermoplastic elastomer composition may include one or more thermoplastic elastomers. The thermoplastic elastomer may be one as generally known in the art. For instance, the thermoplastic elastomer may be a thermoplastic copolyester elastomer, a thermoplastic polyurethane, a thermoplastic styrenic block copolymer, a thermoplastic polyolefin elastomer, a thermoplastic polyamide copolymer, or a mixture thereof. Furthermore, the respective thermoplastic elastomer composition may include such thermoplastic composition.

In one particular embodiment, the thermoplastic elastomer may be a thermoplastic copolyester elastomer. Accordingly, the thermoplastic elastomer composition may be a thermoplastic copolyester elastomer composition. The thermoplastic copolyester elastomer may be a thermoplastic copolyetherester elastomer and/or a thermoplastic copolyesterester elastomer. In one embodiment, the thermoplastic copolyester elastomer may be a thermoplastic copolyesterester elastomer. In one particular embodiment, the thermoplastic copolyester elastomer may be a thermoplastic copolyetherester elastomer.

As indicated above, the thermoplastic copolyester elastomer may be a copolyesterester elastomer. In general, a copolyesterester elastomer is a block copolymer containing (a) a hard polyester segment and (b) a soft polyester segment. Examples of hard polyester segments include, but are not limited to, polyalkylene terephthalates, poly(cyclohexanedicarboxylic acid cyclohexanemethanol), etc. and the like. Examples of soft polyester segments include, but are not limited to, aliphatic polyesters including, but not limited to, polybutylene adipate, polytetramethyladipate and polycaprolactone, etc.

The copolyesterester elastomer may contain one or more blocks of ester units of a high melting polyester and one or more blocks of ester units of a low melting polyester which are linked together through ester groups or urethane groups. Copolyesterester elastomers comprising urethane groups may be prepared by reacting the different polyesters in the molten phase, after which the resulting copolyesterester is reacted with a low molecular weight polyisocyanate. The polyisocyanate may be a diisocyanate or a triisocyanate. In particular, the polyisocyanate may be a diisocyanate, such as a paratoluene diisocyanate, diphenylmethane diisocyanate, xylylene diisocyanate, hexamethylene diisocyanate, and/or isophorone diisocyanate.

As indicated above, the thermoplastic copolyester elastomer may be a copolyetherester elastomer. In general, a copolyetherester elastomer may have a multiplicity of recurring long-chain ester units and short-chain ester units joined head-to-tail through ester linkages. The long-chain ester units can be represented by formula (A):

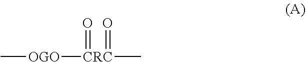

and the short-chain ester units can be represented by formula (B):

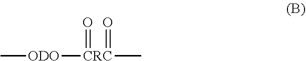

wherein
G is a divalent radical remaining after the removal of the terminal hydroxyl groups from a long chain polymeric glycol having a number average molecular weight of between about 400 and about 6000, preferably between about 400 and about 3000, even more preferably between about 600 and about 3000;
R is a divalent radical remaining after removal of carboxyl groups from a dicarboxylic acid having a number average molecular weight of less than about 300; and
D is a divalent radical remaining after removal of hydroxyl groups from a diol having a number average molecular weight of less than about 250.

As used herein, the term “long-chain ester units” refers to the reaction product of a long-chain glycol with a dicarboxylic acid. The long chain glycols are polymeric glycols having terminal (or nearly terminal as possible) hydroxyl groups. In particular, suitable long-chain glycols include poly(alkylene oxide) glycols having terminal (or as nearly terminal as possible) hydroxyl groups and having a number average molecular weight of from about 400 to about 6000, such as from about 400 to about 3000, such as from about 600 to about 3000, such as from about 1000 to about 3000, such as from about 1000 to about 2000. In addition, the long-chain glycols may have a melting point of less than about 65° C., such as less than about 60° C., such as less than about 55° C., such as less than about 50° C. The long chain glycols are generally poly(alkylene oxide) glycols or glycol esters of poly(alkylene oxide) dicarboxylic acids. Preferred poly(alkylene oxide) glycols include poly(tetramethylene oxide) glycol, poly(trimethylene oxide) glycol, poly(propylene oxide) glycol (e.g., 1,2-or 1,3-propylene oxide), poly(ethylene oxide) glycol, poly(hexamethylene oxide) glycol, poly(heptamethylene oxide) glycol, poly(octamethylene oxide) glycol, poly(nonamethylene oxide) glycol, and poly(1,2-butylene oxide) glycol, copolymer glycols of these alkylene oxides, and block copolymers such as ethylene oxide-capped poly(propylene oxide) glycol. In addition, it should be understood that a mixture of two or more of these glycols may also be utilized. Also, any substituent groups can be present which do not interfere with polymerization of the compound with glycol(s) or dicarboxylic acid(s), as the case may be. The hydroxyl functional groups of the long chain glycols which react to form the copolyester can be terminal groups to the extent possible. The terminal hydroxyl groups can be placed on end capping glycol units different from the chain (e.g., ethylene oxide end groups on poly(propylene oxide glycol). Long chain ester units of Formula (A) may also be referred to as “soft segments” of a copolyetherester elastomer.

As used herein, the term “short-chain ester units” refers to low molecular weight compounds or polymer chain units having a number average molecular weight of less than about 550, such as less than about 525, such as less than about 500, such as less than about 475, such as less than about 450. They can generally be made by reacting a low molecular weight diol or a mixture of diols (molecular weight below about 250, such as below about 225, such as below about 200, such as below about 175, such as below about 150) with a dicarboxylic acid to form ester units represented by Formula (B) above. Short chain ester units of Formula (B) may also be referred to as “hard segments” of the copolyetherester polymer.

Included among the low molecular weight diols which react to form short-chain ester units for preparing copolyesters are acyclic, alicyclic and aromatic dihydroxy compounds. These compounds include diols with about 2 to about 15 carbon atoms, such as about 2 to about 8 carbon atoms, such as about 2 to about 6 carbon atoms, such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. In particular, the diol may be an aliphatic diol, such as 1,4-butanediol, ethylene glycol, 1,3-propanediol, cyclohexanedimethanol, and/or hexamethylene glycol. For instance, the diol may be ethylene glycol, 1,4 butanediol, 1,3-propane diol, or a combination thereof. In particular, the diol may be 1,4 butanediol, 1,3-propane diol, or a combination thereof. In one embodiment, 1,4-butanediol is preferred. In another embodiment, ethylene glycol is preferred. In another further embodiment, 1,3-propanediol is preferred. In one embodiment, 1,4-butanediol may be provided as a mixture with ethylene glycol, 1,3-propanediol, cyclohexanedimethanol, and/or hexamethylene glycol. Included among the bisphenols which can be used are bis(p-hydroxy) diphenyl, bis(p-hydroxyphenyl) methane, and bis(p-hydroxyphenyl) propane. Equivalent ester-forming derivatives of diols are also useful (e.g., ethylene oxide or ethylene carbonate can be used in place of ethylene glycol or resorcinol diacetate can be used in place of resorcinol).

As used herein, the term “diols” includes equivalent ester-forming derivatives such as those mentioned. However, the molecular weight requirements refer to the corresponding diols and not their derivatives.

The dicarboxylic acids that can react with the aforementioned long-chain glycols and low molecular weight diols to produce the copolyetheresters may include aliphatic, cycloaliphatic or aromatic dicarboxylic acids of a low molecular weight (e.g., having a molecular weight of less than about 300, such as less than about 275, such as less than about 250, such as less than about 225). The term “dicarboxylic acids” as used herein includes functional equivalents of dicarboxylic acids that have two carboxyl functional groups that perform substantially like dicarboxylic acids in reaction with glycols and diols in forming thermoplastic copolyetherester elastomers. These equivalents include esters and ester-forming derivatives such as acid halides and anhydrides. The molecular weight requirement pertains to the acid and not to its equivalent ester or ester-forming derivative.

Thus, an ester of a dicarboxylic acid having a molecular weight greater than 300 or a functional equivalent of a dicarboxylic acid having a molecular weight greater than 300 are also suitable, provided the corresponding acid has a molecular weight below about 300 or the aforementioned molecular weights. The dicarboxylic acid can contain any substituent groups or combinations that do not substantially interfere with thermoplastic copolyetherester elastomer formation and use of the thermoplastic copolyetherester elastomer in the composition.

As used herein, the term “aliphatic dicarboxylic acids” refers to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often may not be used because of homopolymerization. However, some unsaturated acids, such as maleic acid, may be used.

As used herein, the term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Representative aliphatic and cycloaliphatic acids that can be used include, but are not limited to, sebacic acid; 1,3-cyclohexane dicarboxylic acid; 1,4-cyclohexane dicarboxylic acid; adipic acid; glutaric acid; succinic acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis (cyclohexyl) carboxylic acid; 3,4-furan dicarboxylic acid; and mixtures thereof. In one embodiment, the preferred acid may include a cyclohexane dicarboxylic acid and/or adipic acid.

Representative aromatic dicarboxylic acids that can be used include, but are not limited to, phthalic, terephthalic and isophthalic acids; dibenzoic acid; substituted dicarboxy compounds with two benzene nuclei such as bis(p-carboxyphenyl) methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives; and mixtures thereof. Hydroxy acids such as p-(beta-hydroxyethoxy)benzoic acid can also be used, provided an aromatic dicarboxylic acid is also used.

In one embodiment, an aromatic dicarboxylic acid is preferred for preparing thermoplastic copolyetherester elastomers. Among the aromatic dicarboxylic acids, those with 8 to 16 carbon atoms, such as 8 to 12 carbon atoms, such as 8 to 10 carbon atoms may be preferred. In particular, the aromatic dicarboxylic acid may include terephthalic acid, phthalic acid, and/or isophthalic acid. In particular, the aromatic dicarboxylic acid may include terephthalic acid, isophthalic acid, or a combination thereof. In one embodiment, the aromatic acid may include terephthalic acid alone or with a mixture of phthalic acid and/or isophthalic acid.

When a mixture of two or more dicarboxylic acids is used to prepare the copolyetherester, isophthalic acid may be a preferred second dicarboxylic acid in one embodiment. For instance, isophthalic acid may be provided in a mixture with terephthalic acid. In this regard, the amount of copolymerized isophthalate residues in the copolyetherester may be less than 35 mole %, such as less than 30 mole %, such as less than 25 mole %. Similarly, copolymerized isophthalate residues in the copolyetherester may be less than 35 wt. %, such as less than 30 wt. %, such as less than 25 wt. %, based on the total weight of copolymerized dicarboxylic acid residues —(—C(O)RC(O)—)— in the copolyetherester. The remainder of the phenylene diradicals may be derived from terephthalic acid based on the total number of moles of copolymerized dicarboxylic acid residues —(—C(O)RC(O)—)— in the copolyetherester.

In addition, in one embodiment, at least about 70 mol. % of the groups represented by R in Formulae (A) and (B) above may be 1,4-phenylene radicals and at least about 70 mol. % of the groups represented by D in Formula (B) above may be 1,4-butylene radicals and the sum of the percentages of R groups which are not 1,4-phenylene radicals and D groups which are not 1,4-butylene radicals may not exceed 30 mol. %.

For example, the copolyetherester may have hard segments composed of polybutylene terephthalate and about 5 wt. % to about 80 wt. %, such as about 5 wt. % to about 75 wt. %, such as about 10 wt. % to about 70 wt. %, such as about 10 wt. % to about 60 wt. %, such as about 20 wt. % to about 60 wt. %, of soft segments composed of the reaction product of a polyether glycol and an aromatic diacid. The polyether blocks may be derived from polytetramethylene glycol. Complementarily, the fraction of hard segments may be about 20 wt. % to about 95 wt. %, such as about 20 wt. % to about 90 wt. %, such as about 30 wt. % to about 90 wt. %, such as about 40 wt. % to about 90 wt. %, such as about 40 wt. % to about 80 wt. %.

While not limited, preferred thermoplastic copolyetherester elastomers include those prepared from monomers comprising the following: (A) (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof; (B) (1) poly(trimethylene oxide) glycol, (2) a dicarboxylic acid selected from isophthalic acid, terephthalic acid or a mixture thereof, and (3) a diol selected from 1,4-butanediol, 1,3-propanediol or a mixture thereof; or (C) (1) ethylene oxide-capped poly(propylene oxide) glycol; (2) a dicarboxylic acid selected from isophthalic acid, terephthalic acid or a mixture thereof; and (3) a diol selected from 1,4-butanediol, 1,3-propanediol or a mixture thereof.

Preferably, the thermoplastic copolyetherester elastomers may be prepared from esters or mixtures of esters of terephthalic acid or isophthalic acid, 1,4-butanediol and poly(tetramethylene ether) glycol, poly(trimethylene ether) glycol, or ethylene oxide-capped polypropylene oxide glycol or may be prepared from esters of terephthalic acid (e.g., dimethylterephthalate), 1,4-butanediol and poly(ethylene oxide)glycol). More preferably, the thermoplastic copolyetherester elastomers may be prepared from esters of terephthalic acid (e.g., dimethylterephthalate), 1,4-butanediol and poly(tetramethylene ether)glycol.

For instance, in one particular embodiment, the thermoplastic copolyetherester elastomer may have the following formula: −[4GT]ₓ−[BT]_{y}−, wherein 4G is the residue of butylene glycol, such as 1,4-butane diol, B is the residue of poly(tetramethylene ether glycol) and T is terephthalate, and wherein x is from about 0.60 to about 0.99 and y is from about 0.01 to about 0.40.

In one aspect, the thermoplastic copolyetherester elastomer can be a block copolymer of polybutylene terephthalate and polyether segments and can have a structure as follows:

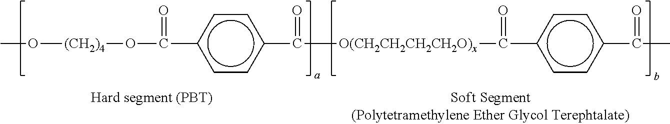

wherein a and b are integers and can vary from 2 to 10,000. The ratio between hard segments and soft segments in the block copolymer as described above can be varied in order to vary the properties of the elastomer.

In general, the thermoplastic copolyetherester elastomer preferably comprises about 1 wt. % or more, such as about 5 wt. % or more, such as about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more of copolymerized residues of long-chain ester units corresponding to Formula (A) above (hard segments). The thermoplastic copolyetherester elastomer preferably comprises about 85 wt. % or less, such as about 80 wt. % or less, such as about 75 wt. % or less, such as about 70 wt. % or less, such as about 65 wt. % or less, such as about 60 wt. % or less of copolymerized residues of long-chain ester units corresponding to Formula (A) above (hard segments).

In general, the thermoplastic copolyetherester elastomer preferably comprises about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more of copolymerized residues of short-chain ester units corresponding to Formula (B) above (soft segments). The thermoplastic copolyetherester elastomer preferably comprises about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less of copolymerized residues of short-chain ester units corresponding to Formula (B) above (soft segments).

In one embodiment, the thermoplastic copolyetherester elastomer may comprise only copolymerized residues of long-chain ester units corresponding to Formula (A) above and short-chain ester units corresponding to Formula (B) above. In this regard, the weight percentages of the copolymerized units of Formula (A) and Formula (B) in the copolyetherester may be complementary. That is, the sum of the weight percentages of the copolymerized units of Formula (A) and Formula (B) may be 100 wt. %. Similarly, the mole percentages of the R groups in the copolymerized units of Formula (A) and Formula (B) in the copolyetherester copolymer may be complementary. That is, the sum of the mole percentages of the R groups in the copolymerized units of Formula (A) and Formula (B) may be 100 mol %.

In one embodiment, the thermoplastic elastomer may be a thermoplastic polyurethane. The thermoplastic polyurethane may be one as generally known in the art. These elastomers may include linear segmented block copolymers composed of hard segments comprising polyisocyanate and a chain extender and soft segments comprising diisocyanate and a long chain polyol as represented by the general formula:

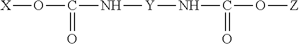

wherein “X” represents a hard segment comprising a polyisocyanate and a chain extender, preferably a short-chain glycol, “Z” represents a soft segment comprising a polyisocyanate and a long-chain polyol, and “Y” represents the residual group of the polyisocyanate compound of the urethane bond linking the X and Z segments. Preferably, the polyisocyanate is a diisocyanate. Examples of suitable diisocyanates include, without limitation, 4,4′-diphenylmethane diisocyanate (MDI), toluene diisocyanate (TDI), hexamethylene diisocyanate (HDI), 4,4′-dicyclohexylmethane diisocyanate (H12-MDI), trans-trans-4,4′-dicyclohexylmethane diisocyanate, 3,3′-dimethyl-4,4′-biphenyl diisocyanate (TODI), 1,4-benzene diisocyanate as well as mixtures thereof. The long-chain polyol includes those of a polyether type, such as poly(alkylene oxide)glycol, or those of polyester type.

In one embodiment, the thermoplastic elastomer may be a thermoplastic styrenic block copolymer. The thermoplastic styrenic block copolymer may be one as generally known in the art. These styrenic block copolymers include block copolymers of styrene and a rubbery polymeric material, such as for example polybutadiene (TPS-SBS), a mixture of hydrogenated polybutadiene and polybutadiene, poly(ethylene-butylene) (TPS-SEBS), polyisoprene (TPS-SIS), and poly(ethylene-propylene) (TPS-SEPS) as well as mixtures thereof.

In one embodiment, the thermoplastic elastomer may be a thermoplastic polyolefin elastomer. The thermoplastic polyolefin elastomer may be one as generally known in the art. These thermoplastic polyolefin elastomers may include certain rubbery olefin-type polymers, for example propylene or polyethylene, as well as thermoplastics blended with a rubber. Examples of thermoplastic polyolefinic elastomers include random block copolymers, such as alpha-olefin copolymers, including ethylene-propylene copolymers (EPM); ethylene propylene diene copolymers (EPDM); copolymers of ethylene or propylene or butene with higher alpha-olefin copolymers (e.g., ethylene-hexene, ethylene-octene); random stereoblock polypropylene; hydrogenated diene block copolymers, such as hydrogenated polybutadiene and hydrogenated polyisoprene; a mixture of hydrogenated polybutadiene and polybutadiene; and graft copolymers such as EPDM-g-polypivalolactone (PPVL). Other examples are polyolefin blend thermoplastic elastomers, such as for example blends of EPM or EPDM with isotactic polypropylene (iPP), and blends of EPM or EPDM with polyethylene and polypropylene.

In one embodiment, the thermoplastic elastomer may be a thermoplastic polyamide copolymer. The thermoplastic polyamide copolymer may be one as generally known in the art. These thermoplastic polyamide copolymers may include copolymers containing a) hard polyamide segments and b) soft and flexible segments. Examples include, without limitation, polyesteramides (PEA), polyetheresteramides (PEEA), polycarbonate-esteramides (PCEA), and polyether-block-amides (PE-b-A) as well as mixtures thereof. Preferably, the thermoplastic polyamide copolymer includes a linear and regular chain of polyamide segments and flexible polyether or polyester segments or soft segments with both ether and ester linkages as represented by formula:

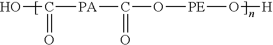

wherein “PA” represents a polyamide sequence and “PE” represents for example a polyoxyalkylene sequence formed from linear or branched aliphatic polyoxyalkylene glycols or a long-chain polyol with either ether or ester linkages, or both, or copolyethers or copolyesters derived therefrom. The polyamide may be aliphatic or aromatic. The softness of the copolyetheramide and the copolyesteramide block copolymers generally decreases as the relative amount of polyamide units is increased.

Furthermore, it should be understood that a mixture of two or more thermoplastic elastomers, such as thermoplastic copolyester elastomers, in particular thermoplastic copolyetherester elastomers, can be used. In one embodiment, the composition may contain one thermoplastic elastomer, such as a thermoplastic copolyester elastomer as defined herein. In other embodiments, the composition may include a mixture of thermoplastic elastomers, such as the thermoplastic copolyester elastomers. For instance, more than one thermoplastic elastomer, such as two or three thermoplastic elastomers, may be utilized in the composition.

Specifically, regarding the thermoplastic copolyester elastomers, in particular a mixture of thermoplastic copolyetherester elastomers, each elastomer used need not on an individual basis come within the values set forth above for the elastomers. In this regard, the mixture of two or more thermoplastic copolyetherester elastomers may conform to the values described herein for the copolyetheresters on a weighted average basis, however. For example, in a mixture that contains equal amounts of two thermoplastic copolyetherester elastomers, one thermoplastic copolyetherester elastomer can contain 60 weight percent short-chain ester units and the other resin can contain 30 weight percent short-chain ester units for a weighted average of 45 weight percent short-chain ester units.

Regarding the properties of the thermoplastic elastomer, such as the thermoplastic copolyester elastomer, it may be desired to have a melt flow that can allow it to be processed in a relatively easy manner for the formation of a composition and resulting part/article as disclosed herein. In this regard, the thermoplastic elastomer, such as the thermoplastic copolyester elastomer, may exhibit a relatively low melt viscosity as indicated by the melt flow rate. For instance, the melt flow rate of the thermoplastic elastomer, such as the thermoplastic copolyester elastomer, may be about 0.5 g/10 min or more, such as about 1 g/10 min or more, such as about 2 g/10 min or more, such as about 3 g/10 min or more, such as about 4 g/10 min or more, such as about 5 g/10 min or more, such as about 7 g/10 min or more, such as about 10 g/10 min or more. The melt flow rate may be about 20 g/10 min or less, such as about 18 g/10 min or less, such as about 15 g/10 min or less, such as about 13 g/10 min or less, such as about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The thermoplastic elastomer, such as the thermoplastic copolyester elastomer, may also have a relatively low melting temperature. For instance, the melting temperature may be about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 240° C. or more. The melting temperature may be about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less. The melting temperature may be determined using means known in the art, such as differential scanning calorimetry in accordance with ISO 11357-1:2023 at a rate of 10° C./min.

In addition, the glass transition temperature of the thermoplastic elastomer, such as the thermoplastic copolyester elastomer, in particular the thermoplastic copolyester elastomer, may be within a particular range. For instance, the glass transition temperature may be about −80° C. or more, such as about −70° C. or more, such as about −60° C. or more, such as about −50° C. or more, such as about −40° C. or more, such as about −30° C. or more. The glass transition temperature may be about 0° C. or less, such as about −5° C. or less, such as about −10° C. or less, such as about −20° C. or less, such as about −30° C. or less, such as about −40° C. or less. Also, the glass transition temperature of the hard segment of the thermoplastic copolyester elastomer may be within a particular range. For instance, the glass transition temperature of the hard segment may be about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about 75° C. or more, such as about 80° C. or more. The glass transition temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 55° C. or less, such as about 50° C. or less, such as about 45° C. or less, such as about 40° C. or less, such as about 35° C. or less, such as about 30° C. or less. The glass transition temperature may be determined using means known in the art, such as differential scanning calorimetry in accordance with ISO 11357-1:2023 at a rate of 10° C./min.

Also, the thermoplastic elastomer, such as the thermoplastic copolyester elastomer, may also have a relatively low Vicat softening temperature. For instance, the Vicat softening temperature may be about 70° C. or more, such as about 80° C. or more, such as about 90° C. or more, such as about 100° C. or more, such as about 110° C. or more, such as about 130° C. or more, such as about 150° C. or more, such as about 170° C. or more. The Vicat softening temperature may be about 250° C. or less, such as about 230° C. or less, such as about 210° C. or less, such as about 200° C. or less, such as about 180° C. or less, such as about 160° C. or less, such as about 140° C. or less, such as about 120° C. or less. The Vicat softening temperature may be determined using means known in the art, such as in accordance with ISO 306:2022 (rate of 50° C./h, 10 N).

Further, the thermoplastic elastomer, such as the thermoplastic copolyester elastomer, may have a particular density. For instance, the density be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The thermoplastic elastomer, such as the thermoplastic copolyester elastomer, may have a density of about 2 g/cm³ or less, such as about 1.8 g/cm³ or less, such as about 1.6 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019.

In addition, the thermoplastic elastomer, such as the thermoplastic copolyester elastomer, utilized may exhibit a certain mechanical strength. In particular, the thermoplastic elastomer, such as the thermoplastic copolyester elastomer, may not be as likely to resist deformation in bending compared to other types of materials and as a result, the thermoplastic elastomer, such as the thermoplastic copolyester elastomer, may exhibit a relatively low flexural modulus. For instance, the flexural modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The flexural modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The flexural modulus may be determined in accordance with ISO 178:2019 at a temperature of about 23° C.

Relatedly, the thermoplastic elastomer, such as the thermoplastic copolyester elastomer, may have a particular Shore D hardness, which can provide an indication of the resistance to indentation of the thermoplastic elastomer, such as the thermoplastic copolyester elastomer. In this regard, the Shore D hardness may be about 15 or more, such as about 20 or more, such as about 25 or more, such as about 30 or more, such as about 35 or more, such as about 40 or more, such as about 45 or more, such as about 50 or more. The Shore D hardness may be about 60 or less, such as about 55 or less, such as about 50 or less, such as about 45 or less, such as about 40 or less, such as about 35 or less, such as about 30 or less. Such hardness may allow for the thermoplastic elastomer, such as the thermoplastic copolyester elastomer, to provide the compliance necessary to effectively function for use in a particular application. The Shore D hardness may be determined in accordance with ISO 868-2003 (15 seconds).

In addition, the thermoplastic elastomer, such as the thermoplastic copolyester elastomer, may have other beneficial mechanical properties. For instance, the tensile stress at break may be about 50 MPa or less, such as about 45 MPa or less, such as about 40 MPa or less, such as about 35 MPa or less, such as about 30 MPa or less, such as about 30 MPa or less, such as about 25 MPa or less. The tensile stress at break may be about 5 MPa or more, such as about 10 MPa or more, such as about 15 MPa or more, such as about 20 MPa or more, such as about 25 MPa or more, such as about 30 MPa or more, such as about 35 MPa or more. The tensile stress at break may be determined in accordance with ISO 527-1/-2 (2012) at a temperature of about 23° C.

Also, the thermoplastic elastomer, such as the thermoplastic copolyester elastomer, may have a relatively high strain at break. The strain at break may be about 200% or more, such as about 225% or more, such as about 250% or more, such as about 275% or more, such as about 300% or more, such as about 325% or more, such as about 350% or more, such as about 375% or more, such as about 400% or more, such as about 450% or more, such as about 500% or more, such as about 600% or more, such as about 800% or more, such as about 1000% or more. The strain at break may be about 2000% or less, such as about 1800% or less, such as about 1600% or less, such as about 1400% or less, such as about 1200% or less, such as about 1000% or less, such as about 900% or less, such as about 800% or less, such as about 700% or less, such as about 600% or less, such as about 550% or less, such as about 500% or less, such as about 475% or less, such as about 450% or less, such as about 425% or less, such as about 400% or less, such as about 375% or less. The strain at break may be determined in accordance with ISO 527-1/-2 (2012) at a temperature of about 23° C.

Also, the thermoplastic elastomer, such as the thermoplastic copolyester elastomer, may have a relatively high nominal strain at break. For instance, the nominal strain at break may be about 500% or more, such as about 550% or more, such as about 600% or more, such as about 650% or more, such as about 700% or more, such as about 750% or more, such as about 800% or more, such as about 850% or more. The nominal strain at break may be about 2000% or less, such as about 1800% or less, such as about 1600% or less, such as about 1400% or less, such as about 1200% or less, such as about 1100% or less, such as about 1000% or less, such as about 950% or less, such as about 900% or less, such as about 850% or less, such as about 800% or less. The nominal strain at break may be determined in accordance with ISO 527-1/-2 (2012) at a temperature of about 23° C.

Further, the tensile modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The tensile modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The tensile modulus may be determined in accordance with ISO 527-1/-2 (2012) at a temperature of about 23° C.

The thermoplastic elastomer composition, such as the thermoplastic copolyester elastomer composition, may generally comprise about 3 wt. % or more, such as about 5 wt. % or more, such as about 10 wt. % or more, such as about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more, such as about 60 wt. % or more, such as about 65 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 98 wt. % or more, such as about 99 wt. % or more of the thermoplastic elastomer, such as the thermoplastic copolyester elastomer, based on the weight of the thermoplastic elastomer composition, such as the thermoplastic copolyester elastomer composition. The thermoplastic elastomer composition, such as the thermoplastic copolyester elastomer composition, may comprise 100 wt. % or less, such as about 99 wt. % or less, such as about 98 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less, such as about 20 wt. % or less, such as about 15 wt. % or less, such as about 10 wt. % or less of the thermoplastic elastomer, such as the thermoplastic copolyester elastomer, based on the weight of the thermoplastic elastomer composition, such as the thermoplastic copolyester elastomer composition.

### B. Additives

In addition to the thermoplastic elastomer, such as the thermoplastic copolyester elastomer, the thermoplastic elastomer composition, such as the thermoplastic copolyester elastomer composition, may optionally comprise one or more additives, such as those mentioned below. In this regard, in one embodiment, the thermoplastic elastomer composition may further comprise one or more additives. For instance, the additives may include those typically utilized in the art in order to provide a resulting composition or material (e.g., fiber/filament, yarn, fabric, and/or article) having the desired properties. These additives may include, but are not limited to, fillers (e.g., fibrous fillers), reinforcing agents, process aids, plasticizers, stabilizers (e.g., heat stabilizers; UV light stabilizers; metal deactivators; antioxidants such as phenolic, phosphite, and/or amine containing antioxidants; etc.), viscosity modifiers, nucleating agents, lubricants, flow enhancing additives, flame retardants (e.g., phosphates such as polyphosphates, pyrophosphates, etc.; phosphinates; etc.), impact modifiers, antistatic agents, antimicrobial agents, colorants, pigments, etc.

When utilized, the respective additive may be present in the thermoplastic elastomer composition in an amount of about 0.01 wt. % or more, such as about 0.05 wt. % or more, such as about 0.1 wt. % or more, such as about 0.2 wt. % or more, such as about 0.3 wt. % or more, such as about 0.5 wt. % or more, such as about 0.8 wt. % or more, such as about 1 wt. % or more, such as about 1.5 wt. % or more, such as about 2 wt. % or more, such as about 2.5 wt. % or more, such as about 3 wt. % or more, such as about 5 wt. % or more based on the weight of the thermoplastic elastomer composition, such as the thermoplastic copolyester elastomer composition. The respective additive may be present in the thermoplastic elastomer composition in an amount of about 20 wt. % or less, such as about 15 wt. % or less, such as about 12 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.8 wt. % or less, such as about 2.5 wt. % or less, such as about 2.3 wt. % or less, such as about 2 wt. % or less, such as about 1.8 wt. % or less, such as about 1.6 wt. % or less, such as about 1.4 wt. % or less, such as about 1.2 wt. % or less, such as about 1 wt. % or less, such as about 0.8 wt. % or less, such as about 0.5 wt. % or less based on the weight of the thermoplastic elastomer composition, such as the thermoplastic copolyester elastomer composition. In another embodiment, the aforementioned weight percentages may be based on the weight of the thermoplastic elastomer in the thermoplastic elastomer composition. In addition, it should be understood that in one embodiment, a respective additive may be present in the thermoplastic elastomer composition in an amount of 0 wt. %.

### II. Composition Formation

The thermoplastic elastomer composition described herein can be processed using techniques generally known in the art. For instance, the components (thermoplastic elastomer and optional additives) may be melt-mixed (also referred to as melt-blended). Utilizing such an approach, the components may be well-dispersed throughout the composition. Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, such as a Banbury™ mixer or a Brabender™ mixer, an extruder, such as a co-rotating extruder, a counter-rotating extruder, or a twin-screw extruder, a co-kneader, such as a Buss® kneader, etc. The melt blending may be carried out at a temperature ranging from 150 to 300° C., such as from 200 to 280° C., such as from 220 to 270° C. or 240 to 260° C. However, such processing should be conducted for each respective composition at a desired temperature to minimize any degradation. Upon completion of the mixing/blending, the composition may be milled, chopped, extruded, pelletized, or processed by any other desirable technique. In certain instances, the components may be melt-blended and directly fed to a downstream operation, such as a spinneret for forming fibers (interchangeably referred to as filaments) and yarns as disclosed herein. In particular, once formed, the thermoplastic elastomer composition may be utilized to form fibers (or filaments) and yarns as further described herein.

### III. Fibers and Yarns

As indicated herein, the thermoplastic elastomer and corresponding composition are suitable for forming fibers and corresponding yarns. While the thermoplastic elastomer and corresponding composition may be utilized to form short fiber yarns, in one particular embodiment, they may be utilized to form continuous fibers (or filaments) and corresponding yarns. In particular, the properties of the thermoplastic elastomer allow it to be processed to form fibers/filaments at speeds and conditions as disclosed herein and thereafter allow the fibers/filaments to be processed to form yarns and resulting fabrics and articles.

Furthermore, in one embodiment, the yarn may a monofilament (or monofiber) yarn. In this regard, the yarn may simply be formed from the thermoplastic elastomer and/or corresponding composition. In another embodiment, the yarn may be a multifilament (or multifiber) yarn. In this regard, the yarn may also be formed from the thermoplastic elastomer and/or corresponding composition. In one embodiment, such multifilament yarn may include a second type of material. For instance, such second type of material may be any material generally known in the art for forming fibers/filaments and yarns.

The fibers/filaments of the present disclosure can be made using conventional processes known in the art. For example, these processes may include general steps such as spinning and optionally drawing the thermoplastic elastomer composition, including the thermoplastic elastomer, into a fiber/filament. The fibers/filaments may also be treated mechanically and/or chemically (e.g., via finishes) to impart desirable characteristics such as strength, elasticity, heat resistance, feel, etc. depending on the desired properties and characteristics of the resulting article made from the fibers/filaments and yarns.

In one particular embodiment, the fibers/filaments may be formed via melt spinning. Accordingly, the fibers/filaments may be melt spun fibers/filaments. Generally, melt spinning includes heating the thermoplastic elastomer and corresponding composition including the thermoplastic elastomer to form a melt (also referred to as an elastomer melt) wherein such melting can be conducted by heating the thermoplastic elastomer against a heated surface. As an example, the thermoplastic elastomer may be heated in a mixer or an extruder and thereafter provided or metered to a spinneret. The temperature of operation may correspond to the melting temperature of the thermoplastic elastomer; for instance, the temperature may be relatively higher than the melting temperature of the thermoplastic elastomer in order to allow for the formation of an elastomer melt. Regardless, the operation temperature may be within the ranges of the melting temperature of the thermoplastic elastomer as defined above.

The spinneret may include a plurality of orifices or capillaries having a particular size and design that allows for the formation of a fiber/filament having the desired configuration and cross-section. Accordingly, this process allows fibers/filaments of various sizes and cross sections to be formed, including fibers/filaments having, for example, round, elliptical, square, rectangular, lobed or dog-boned cross sections, etc.

Once extruded through the spinneret, the fibers/filaments may be quenched. For instance, the fibers/filaments can be contacted with a non-reactive gas stream (e.g., air) or a liquid (e.g., water) to assist in solidifying the fibers/filaments. As an example, a fiber/filament may be quenched while traversing in a general vertical direction using a non-reactive gas stream, such as air. In another embodiment, a fiber/filament may be quenched while traversing in a relatively horizontal direction through a liquid. In addition, in one embodiment, additional quenching may not be necessary and sufficient quenching may be conducted based on ambient conditions. Thereafter, the fibers/filaments are collected downstream from the spinneret using a guide and can be taken up by a roller or a plurality of rollers.

The thermoplastic elastomer can be spun at speeds of from about 200 to about 6000 meters per minute (m/min), depending on the desired fiber/filament size. When forming the fibers/filaments, the spinning speed may be at least about 200 m/min, such as at least about 400 m/min, such as at least about 500 m/min, such as at least about 600 m/min, such as at least about 800 m/min, such as at least about 1000 m/min, such as at least about 2000 m/min. The spinning speed may be about 6000 m/min or less, such as about 5000 m/min or less, such as about 4000 m/min or less, such as about 3000 m/min or less, such as about 2500 m/min or less, such as about 2000 m/min or less, such as about 1800 m/min or less, such as about 1600 m/min or less, such as about 1400 m/min or less, such as about 1200 m/min or less, such as about 1000 m/min or less.

In addition, a finish may be applied to the fibers/filaments. The finish may be applied for facilitating spinning and/or subsequent processing. For instance, the finish may be applied to impart lubrication thereby minimizing friction. The finish generally includes an oil (finish oil). In this regard, the finish oil may include, but is not limited to, a silicone oil, a mineral oil, an ester oil, and the like as well as mixtures thereof. In one embodiment, the finish oil may include a silicone oil. In another embodiment, the finish oil may include a mineral oil. In a further embodiment, the finish oil may include an ester oil. However, it should be understood that other finish oils utilized for thermoplastic elastomers may also be utilized. In addition, the finish may also include other additives generally utilized in the art. In this regard, the finish may include a salt of a fatty acid, in particular a metal salt of a fatty acid. For instance, the fatty acid salt may be a stearate in one embodiment. Accordingly, these additives within the finish may include, but are not limited to, sodium palmitate, sodium stearate, magnesium stearate, potassium stearate, potassium palmitate, potassium myristate, sodium myristate, calcium stearate, calcium laurate, zinc stearate, and mixtures thereof.

Such application of finish may be conducted before drawing an undrawn fiber/filament, if drawing such fiber/filament. In addition, it may be done after quenching. In one embodiment, such application may be conducted during quenching; in such instance, the fiber/filament and/or yarn may have a crimp, such as a helical crimp.

Following extrusion from the spinneret, the fiber/filament may be drawn. The drawing may assist with achieving desirable properties, such as increasing amorphous orientation, shrinkage, modulus, and/or strength. However, it should be understood that in certain embodiments, drawing may not be conducted such that the fiber/filament produced is an undrawn fiber/filament. In such embodiments, the fiber/filament may still nonetheless have certain desirable properties. When conducted, the drawing can be done in combination with take-up by using a series of rollers or pins, some of which may be generally heated, or it can be done as a separate stage in the process of the fiber/filament formation. If heated, the drawing can be carried out at about 15° C.-150° C., such as from about 15° C.-130°C., such as from about 15° C.-100° C., such as from about 15° C.-80°C., such as from about 15° C.-60° C., such as from about 15° C.-40° C.

The godet roll speed, typically between a feed roll and a winding roll and which may be utilizing for drawing under certain conditions, may be from about 200 to about 6000 meters per minute (m/min). For instance, the speed may be at least about 200 m/min, such as at least about 400 m/min, such as at least about 500 m/min, such as at least about 600 m/min, such as at least about 800 m/min, such as at least about 1000 m/min, such as at least about 1250 m/min, such as at least about 1500 m/min, such as at least about 1750 m/min, such as at least about 2000 m/min. The speed may be about 6000 m/min or less, such as about 5000 m/min or less, such as about 4000 m/min or less, such as about 3000 m/min or less, such as about 2750 m/min or less, such as about 2500 m/min or less, such as about 2250 m/min or less, such as about 2000 m/min or less, such as about 1800 m/min or less, such as about 1600 m/min or less, such as about 1400 m/min or less, such as about 1200 m/min or less, such as about 1000 m/min or less.

The fibers/filaments may be drawn at any desired draw ratio depending on the desired properties, short of that which interferes with processing by breaking a fiber/filament. In this regard, the fibers/filaments may be drawn from 0× to about 6×, such as from about 0.9× to about 6×, such as from about 1.1× to about 6×. For instance, the fibers/filaments may be drawn at 0× or more, such as at least about 0.2×, such as at least about 0.3×, such as at least about 0.5×, such as at least about 0.7×, such as at least about 0.9×, such as at least about 1.1×, such as at least bout 1.2×, such as at least about 1.3×, such as at least about 1.4×, such as at least about 1.5×, such as at least about 1.8×, such as at least about 2×, such as at least about 2.2×, such as at least about 2.4×, such as at least about 2.5×. The fibers/filaments may be drawn about 5× or less, such as about 4.5× or less, such as about 4× or less, such as about 3.5× or less, such as about 3× or less, such as about 2.8× or less, such as about 2.6× or less, such as about 2.4× or less, such as about 2.2× or less, such as about 2× or less. Such drawing may be conducted in a single step draw in one embodiment. In another embodiment, however, the fibers/filaments may not be drawn.

The resulting fiber/filament and/or yarn is also amenable to further processing through the use of additional processing equipment, or it may be used directly in applications requiring a continuous fiber/filament and/or yarn. Regarding further processing, the fiber/filament and/or yarn subsequently may be textured through known false twist texturing conditions or other processes. It may also be desirable to increase the surface area of the fiber/filament and/or yarn to provide a softer feel and to enhance the ability to breathe, thereby providing better insulation and water retention in the case of textiles. To increase the surface area, the fiber/filament and/or yarn may be crimped or twisted, such as by a false twist method, an air jet, an edge crimp, a gear crimp, a stuffer box, etc. for example. In the case of an elastomeric yarn, a “bulking” type process to heat the yarn with minimal tension may also be performed to allow the yarn to relax and shrink, which may increase the elongation to break and thermal stability by heat history of the yarn. The method utilized may be dictated by the particular application for the fiber/filament.

In addition, after formation, the fiber/filament and/or yarn may be treated by any method appropriate to the desired final use. For instance, in particular regarding textiles, this may include dyeing, coloring with pigments, sizing, or the addition of chemical agents such as antistatic agents, flame retardants, UV light stabilizers, antioxidants, pigments, dyes, stain resistants, and/or antimicrobial agents. In addition, the fibers/filaments and/or yarn may be treated to impart additional desired characteristics such as strength, elasticity or shrinkage. While the fibers/filaments and yarns may be treated using such techniques, it should be understood that the resulting article may also be treated using such techniques. Nevertheless, examples of suitable treatments and application methods are found in “Textile coloration and finishing,” by Warren S. Perkins, Carolina Academic Press, Durham, NC, 1996.

Thus, generally, the method of making a fiber/filament or a yarn, such as a monofilament yarn, as disclosed herein may include at least the following: extruding a melt comprising the thermoplastic elastomer composition comprising the thermoplastic elastomer through a spinneret; withdrawing a fiber/filament from the spinneret; and collecting the fiber/filament on a winding roller. In addition, the method may also comprise quenching the fiber/filament using air. Such quenching may be conducted before drawing, if drawing is conducted, the fiber/filament. Also, the method may comprise applying a finish to the fiber/filament. Such application may also be conducted before drawing, if drawing is conducted, the fiber/filament; in addition, it may be done after quenching. Also, the method may include a step of drawing the fiber/filament using a draw roller. Such drawing may be conducted after quenching and/or after applying a finish.

Further, generally, the method of making a multifilament yarn as disclosed herein may include at least the following: extruding a melt comprising the thermoplastic elastomer composition comprising the thermoplastic elastomer through a spinneret; withdrawing a first fiber/filament and a second fiber/filament from the spinneret; and collecting the first fiber/filament and the second fiber/filament on a winding roller. When a third fiber/filament (or more) is present, the aforementioned steps may be the same for forming the third fiber/filament. In addition, the method may also comprise quenching the first fiber/filament and the second fiber/filament using air. Such quenching may be conducted before drawing, if drawing is conducted, the fiber/filament. If present, quenching may also be conducted on a third fiber/filament. Also, the method may comprise applying a finish to the first fiber/filament and the second fiber/filament. Such application may also be conducted before drawing, if drawing is conducted, the fiber/filament; in addition, it may be done after quenching. If present, application of the finish may also be conducted on a third fiber/filament. Also, the method may include a step of drawing the first fiber/filament and the second fiber/filament using a draw roller. Such drawing may be conducted after quenching and/or after applying a finish. The method may also include a step of drawing a third fiber/filament, if present. In addition, the method of making the multifilament yarn may also include a step of converging the fibers/filaments to form the multifilament yarn.

However, it should be understood that other methods of making multifilament yarns as known in the art may also be utilized. For instance, such methods may be utilized when the fibers/filaments of the multifilament yarn are formed from different materials. For instance, as indicated here, a respective yarn may include a first fiber formed from a fiber-forming material and a second fiber formed from a thermoplastic elastomer. In this regard, separate monofilaments or fibers of the first fiber as mentioned herein and a second fiber of the thermoplastic elastomer may be formed. Then, post formation, such respective fibers may be spun to form a respective multifilament yarn.

Further in accordance with the present disclosure, a melt spinning process is also disclosed for spinning fibers/filaments, in particular continuous fibers/filaments. In general, the process comprises passing a melt comprising a thermoplastic elastomer composition, including a thermoplastic elastomer, through a spinneret to form a plurality of stretchable, synthetic elastomeric fibers/filaments. A thermoplastic elastomer composition supply (e.g., in granular, pellet, or other form such as a melt) may be introduced to a spinneret. The molten fibers/filaments may be extruded through the spinneret. The elastomer may be extruded as undrawn fibers/filaments from the spinneret having orifices designed to give a desired cross section. In addition, the process may further include quenching the fibers/filaments after they exit the capillary of the spinneret to cool and/or solidify the fibers/filaments in any known manner, for example by cool air. Any suitable quenching method may be used, such as in-flow quenching, out-flow quenching, cross-flow quenching, and/or radial flow quenching.

These fibers/filaments can then be drawn if desired after quenching. The fibers/filaments may be drawn in at least one drawing step, for example between a feed roll (which can be operated at 150 to 1000 m/minute) and a draw roll to form a drawn fiber/filament. The drawing step can be coupled with spinning to make a drawn yarn. Drawing can also be accomplished during winding the fibers/filaments as a warp of yarns, referred to as “draw warping.” Herein, the draw ratio may be the draw roll peripheral speed divided by the feed roll peripheral speed.

The fiber/filament, which may or may not be drawn optionally can be partly relaxed, for example, with steam. Any amount of heat-relaxation can be carried out during spinning. In this regard, the fiber/filament may be dry or wet heat-treated while relaxed to develop the desired stretch/stiffness and recovery properties. Such relaxation can be accomplished during fiber/filament production, for example during the above-described relaxation step or after the fiber/filament has been incorporated into a yarn or a fabric, for example during scouring, dyeing, and the like. Heat-treatment in fiber/filament or yarn form can be carried out using hot rolls or a hot chest or in a jet-screen bulking step, for example. It may be preferred that such relaxed heat-treatment be performed after the fiber/filament is in a yarn or a fabric so that up to that time it can be processed like a non-elastomeric fiber/filament; however, if desired, it can be heat-treated and fully relaxed before being wound up as a fiber/filament. For greater uniformity in the final fabric, the fiber/filament can be uniformly heat-treated and relaxed. The heat-treating/relaxation temperature can be in the range of about 80° C. to about 150° C. when the heating medium is dry air or steam, about 75° C. to about 100° C. when the heating medium is hot water, and about 101° C. to about 115° C. when the heating medium is super atmospheric pressure steam. Generally, lower temperatures may result in too little or no heat-treatment and higher temperatures may melt the thermoplastic elastomer. Furthermore, the heat-treating/relaxation step can generally be accomplished in a few seconds. Without intending to be limited, generally, the greater the relaxation, the more elastic the fiber/filament and the less shrinkage that may occur in downstream operations. In addition, without intending to be limited, such treatment may also allow the resulting article (e.g., garment), fabric, and/or yarn to be thermally stable for post-treatment processes, such as screen printing, sublimation dyeing, etc.

In addition, relaxation of the fibers/filaments may be conducted by utilizing the rolls/rollers present within the process. For instance, as disclosed herein, the process may include a feed roller to which a fiber/filament may be withdrawn from the spinneret. The process may also include a draw roller or godet roller after the feed roller. Finally, the fiber/filament/yarn may be taken up by a winding roller. By controlling the speeds of the respective rollers, the fiber/filament and/or yarn may have an opportunity to relax. For instance, in one embodiment, the feed roller speed may be greater than a draw roller speed or if no drawing, a godet roller speed. In one embodiment, the draw roller speed or if no drawing, a godet roller speed may be greater than a winding roller speed. In a further embodiment, the feed roller speed may be greater than a draw roller speed or if no drawing, a godet roller speed and the draw roller speed or if no drawing, the godet roller speed may be greater than a winding roller speed.

The quenched, optionally drawn, and optionally relaxed fibers/filaments can then be collected by winding at the winder. The winder may also be referred to as a take up roll. The winding speed may be from about 200 to about 6000 meters per minute (m/min). For instance, the winding speed may be at least about 200 m/min, such as at least about 400 m/min, such as at least about 500 m/min, such as at least about 600 m/min, such as at least about 800 m/min, such as at least about 1000 m/min, such as at least about 1250 m/min, such as at least about 1500 m/min, such as at least about 1750 m/min, such as at least about 2000 m/min. The winding speed may be about 6000 m/min or less, such as about 5000 m/min or less, such as about 4000 m/min or less, such as about 3000 m/min or less, such as about 2750 m/min or less, such as about 2500 m/min or less, such as about 2250 m/min or less, such as about 2000 m/min or less, such as about 1800 m/min or less, such as about 1600 m/min or less, such as about 1400 m/min or less, such as about 1200 m/min or less, such as about 1000 m/min or less.

In one embodiment, the winding speed may be less than the draw (or godet) roll speed. For instance, the draw (or godet) roll speed may be 75% or more, such as 80% or more such as 85% or more, such as 88% or more, such as 90% or more, such as 92% or more, such as 94% or more, such as 95% or more, such as 96% or more, such as 97% or more, such as 97.5% or more, such as 98% or more, such as 98.5% or more, such as 99% or more to less than 100% of the winding speed. Without intending to be limited by theory, it is believed that such difference in speeds may allow for the fiber(s)/filament(s) and yarn to have an opportunity to at least partially relax.

If multiple fibers/filaments have been spun and quenched, the fibers/filaments can be converged, optionally interlaced, and then wound up. For instance, such convergence and/or interlacing may be conducted to form multifilament yarns. Single fiber/filament or multifilament yarns may be wound up at the winder in the same manner. Where multiple fibers/filaments have been spun and quenched, the fibers/filaments can be converged and optionally interlaced prior to winding as is done in the art. The convergence may occur at multiple points of the process. For example, the convergence may be at a feed roll or before a feed roll, such as at a finish applicator.

As indicated herein, the fibers/filaments may be utilized to make a yarn. A yarn may include, but is not limited to, a number of fibers/filaments twisted together (spun yarn), a number of fibers/filaments laid together without twist (a zero-twist yarn), a number of fibers/filaments laid together with a degree of twist, and a single fiber/filament with or without twist (a monofilament).

In one embodiment, a multifilament yarn as disclosed herein may have no twist. In another embodiment, the multifilament yarn as disclosed herein may have a relatively small degree of twist. For instance, the twist may be 1 or less twists per inch, such as 0.9 or less twists per inch, such as 0.8 or less twists per inch, such as 0.7 or less twists per inch, such as 0.6 or less twists per inch, such as 0.5 or less twists per inch, such as 0.4 or less twists per inch, such as 0.3 or less twists per inch, such as 0.2 or less twists per inch, such as 0.1 or less twists per inch, such as 0.05 or less twists per inch, such as 0.01 or less twists per inch. The twist may be 0 or more twists per inch, such as 0.01 or more twists per inch, such as 0.05 or more twists per inch, such as 0.1 or more twists per inch, such as 0.2 or more twists per inch, such as 0.3 or more twists per inch, such as 0.4 or more twists per inch, such as 0.5 or more twists per inch.

As indicated herein, the yarn may generally have any fiber/filament count. For instance, the yarn may be a monofilament yarn formed from a single fiber/filament. Alternatively, the yarn may be a multifilament yarn formed from two or more fibers/filaments wherein such two or more fibers/filaments may be wound to form the yarn. Accordingly, the multifilament yarn comprises a first fiber/filament and a second fiber/filament. In addition, the multifilament yarn may further comprise a third fiber/filament. In particular, the multifilament yarn may include a first fiber/filament, a second fiber/filament, and a third fiber/filament. In one embodiment, the fibers/filaments of the multifilament yarn may be formed from the same material.

In this regard, the multifilament yarn may comprise at least about 2 fibers/filaments. The multifilament yarns may comprise about 2 or more, such as about 3 or more, such as about 5 or more, such as about 10 or more, such as about 15 or more, such as about 20 or more, such as about 25 or more, such as about 50 or more, such as about 100 or more fibers/filaments. The multifilament yarn may comprise about 200 or less, such as about 100 or less, such as about 80 or less, such as about 60 or less, such as about 50 or less, such as about 40 or less, such as about 35 or less, such as about 30 or less, such as about 25 or less, such as about 20 or less, such as about 15 or less, such as about 10 or less, such as about 5 or less, such as about 4 or less, such as about 3 or less fibers/filaments.

The yarns may have a total denier of from about 1 to about 2000. For instance, the total denier may be about 1 or more, such as about 5 or more, such as about 10 or more, such as about 20 or more, such as about 30 or more, such as about 40 or more, such as about 50 or more, such as about 70 or more, such as about 100 more, such as about 120 or more, such as about 140 or more, such as about 160 or more, such as about 180 or more, such as about 200 or more, such as about 300 or more, such as about 500 or more, such as about 800 or more, such as about 1000 or more, such as about 1300 or more, such as about 1500 or more, such as about 1800 or more, such as about 2000 or more. The total denier may be about 3000 or less, such as about 2800 or less, such as about 2500 or less, such as about 2200 or less, such as about 2000 or less, such as about 1800 or less, such as about 1600 or less, such as about 1400 or less, such as about 1200 or less, such as about 1000 or less, such as about 800 or less, such as about 600 or less, such as about 500 or less, such as about 450 or less, such as about 400 or less, such as about 350 or less, such as about 300 or less, such as about 275 or less, such as about 250 or less, such as about 225 or less, such as about 200 or less, such as about 180 or less, such as about 160 or less, such as about 140 or less, such as about 120 or less, such as about 100 or less, such as about 80 or less, such as about 60 or less, such as about 50 or less. The denier may be determined in accordance with D2259-02 (2016) at a temperature of about 23° C.

In addition, the yarn may have a particular linear density as it relates to the fibers/filaments that make up the yarn. For instance, the yarn may have at least about 0.1 denier per filament (or fiber) (dpf), such as at least about 0.2 dpf, such as at least about 0.5 dpf, such as at least about 0.7 dpf, such as at least about 1 dpf, such as at least about 2 dpf, such as at least about 3 dpf, such as at least about 4 dpf, such as at least about 5 dpf, such as at least about 8 dpf, such as at least about 10 dpf, such as at least about 20 dpf, such as at least about 30 dpf, such as at least about 50 dpf, such as at least about 70 dpf, such as at least about 90 dpf, such as at least about 110 dpf, such as at least about 130 dpf, such as at least about 150 dpf, such as at least about 200 dpf, such as at least about 300 dpf, such as at least about 500 dpf, such as at least about 800 dpf, such as at least about 1,000 dpf, such as at least about 1,200 dpf, such as at least about 1,400 dpf, such as at least about 1,600 dpf. The yarn may have about 2,000 dpf or less, such as about 1,700 dpf or less, such as about 1,500 dpf or less, such as about 1,300 dpf or less, such as about 1,100 dpf or less, such as about 900 dpf or less, such as about 700 dpf or less, such as about 500 dpf or less, such as about 450 dpf or less, such as about 400 dpf or less, such as about 350 dpf or less, such as about 300 dpf or less, such as about 250 dpf or less, such as about 200 dpf or less, such as about 180 dpf or less, such as about 150 dpf or less, such as 130 pdf or less, such as 110 dpf or less, such as 100 dpf or less, such as 90 dpf or less, such as 80 dpf or less, such as 70 dpf or less, such as 60 dpf or less, such as 50 or less dpf, such as about 40 or less dpf, such as about 35 or less dpf, such as about 30 or less dpf, such as about 25 or less dpf, such as about 22 or less dpf, such as about 20 or less dpf, such as about 18 or less dpf, such as about 16 or less dpf, such as about 14 or less dpf, such as about 12 or less dpf, such as about 10 or less dpf, such as about 8 or less dpf, such as about 6 or less dpf, such as about 5 or less dpf, such as about 4 or less dpf, such as about 3.5 or less dpf, such as about 3 or less dpf, such as about 2.5 or less dpf. In one embodiment, such aforementioned linear density may refer to a particular type of fiber (e.g., first fiber or second fiber) as defined herein. Without intending to be limited, the dpf may be relatively lower for certain applications than other applications. For instance, the dpf may be relatively lower for textile applications than for industrial applications. Regardless, the size and strength of such a fiber/filament can be readily determined using means generally known in the art.

As indicated herein, the fabric includes a first fabric section and a second fabric section. The first fabric section comprises a plurality of fibers comprising a first fiber comprising a fiber-forming material and a second fiber comprising a thermoplastic elastomer and the second fabric section comprises the first fiber extending from the first fabric section wherein the first fiber is at least partially coated with the thermoplastic elastomer.

In this regard, the fiber-forming material for the first fiber may be any material generally known in the art for forming fibers/filaments and yarns. In one embodiment, it may be an elastic material. In another embodiment, it may be a non-elastic material. In one embodiment, the fiber-forming material may not be a thermoplastic elastomer. In this regard, the fiber-forming material may be a non-thermoplastic elastomer. The fiber-forming material may be cellulosic (e.g., cotton, bamboo), proteinaceous (e.g., wool, silk, and soybean), polyester (e.g., polyethylene terephthalate, polytrimethylene terephthalate), polyamide (e.g., nylon, polycaprolactam, poly(hexamethylene adipamide), aramid), acrylic, acetate, rayon, etc. Further, the fiber-forming material may be a thermoplastic in one embodiment, such that it has a glass transition temperature and/or a melting temperature. In another embodiment, the fiber-forming material may be a thermoset such that it has a degradation temperature.

In this regard, the fiber-forming material may have a melting temperature or degradation temperature higher than the melting temperature of the thermoplastic elastomer. For instance, the fiber-forming material may have a melting temperature that is at least 20° C., such as at least 30° C., such as at least 40° C., such as at least 50° C., such as at least 60° C., such as at least 70° C., such as at least 80° C., such as at least 90° C., such as at least 100° C. greater than the melting temperature of the thermoplastic elastomer. The melting temperature of the fiber-forming material may be within 200° C. greater, such as within 180° C. greater, such as within 160° C. greater, such as within 140° C. greater, such as within 120° C. greater, such as within 100° C. greater, such as within 80° C. greater, such as within 60° C. greater than the melting temperature of the thermoplastic elastomer. In the event the material is not a thermoplastic, the degradation temperature of such fiber-forming material may be at least 20° C., such as at least 30° C., such as at least 40° C., such as at least 50° C., such as at least 60° C., such as at least 70° C., such as at least 80° C., such as at least 90° C., such as at least 100° C. greater than the melting temperature of the thermoplastic elastomer. The degradation temperature of the fiber-forming material may be within 200° C. greater, such as within 180° C. greater, such as within 160° C. greater, such as within 140° C. greater, such as within 120° C. greater, such as within 100° C. greater, such as within 80° C. greater, such as within 60° C. greater than the melting temperature of the thermoplastic elastomer. As a result, as further described below, such first fiber and corresponding fiber-forming material may not melt or degrade in the respective second fabric section when subjected to elevated temperatures during processing for forming selective areas within the fabric for obtaining desired properties.

The fibers/filaments formed from the fiber-forming material can be made using conventional processes known in the art. For example, these processes may include general steps such as spinning and optionally drawing the fiber-forming material into a fiber/filament. The fibers/filaments may also be treated mechanically and/or chemically (e.g., via finishes) to impart desirable characteristics such as strength, elasticity, heat resistance, feel, etc. depending on the desired properties and characteristics of the resulting article made from the fibers/filaments and yarns.

The resulting fibers and/or yarns may include a thermoplastic elastomer-based fiber and/or yarn in a particular amount. For instance, the thermoplastic elastomer may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the yarn. The thermoplastic elastomer may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less. In one embodiment, the aforementioned may be based on the weight of the fibers. In another embodiment, the aforementioned may be based on the weight of a respective fabric section. In a further embodiment, the aforementioned may be based on the weight of a fabric.

### IV. Articles

The present inventor has discovered that the advantageous properties of the fabric as disclosed herein can allow for it to be utilized to form various articles for various applications. In general, the fabric and respective fabric sections are formed from a plurality of fibers. For instance, such plurality of fibers includes a first fiber formed from a fiber-forming material and a second fiber formed from a thermoplastic elastomer. In this regard, such plurality of fibers may be presented in various configurations. For example, in one embodiment, a yarn, such as a first yarn, may be provided including the first fiber formed from a fiber-forming material and the second fiber formed from a thermoplastic elastomer. Accordingly, such single yarn may include both types of fibers. In another embodiment, the fabric and respective fabric section may include two yarns. For instance, it may include a first yarn and a second yarn. The first yarn may include a plurality of fibers including a first fiber formed from a fiber-forming material. The second yarn may include a second fiber formed from a thermoplastic elastomer. In one embodiment, the second yarn may also include a plurality of fibers including a second fiber formed from a thermoplastic elastomer. Accordingly, such respective fibers may be present in the fabric and respective fabric sections in various configurations.

Nevertheless, the fibers/filaments may be utilized to form yarns which may be used to prepare woven, knit, and/or nonwoven fabrics and resulting articles which can be prepared using conventional techniques including, but not limited to, meltblown, spunbonded, card and bond, including heat bonding (hot air and point bonding), air entanglement, and other techniques. For instance, they may be subjected to various high-speed conditions for the formation of such articles.

In addition, the configuration of the yarn may depend on the particular application. For instance, the yarn may be utilized as a bare yarn or a covered yarn. In one embodiment, the yarns may be utilized themselves as bare yarns. Alternatively, the yarns may be used as covered yarns wherein the yarn as described herein may be utilized as the core. For such covered yarn, an inelastic fiber/filament or yarn or a short fiber yarn may wrap the core, in particular in a spiral manner. In addition or alternatively, another elastic yarn may also be utilized to cover.

Further, the yarns may be utilized to make fabrics, such as knit fabrics or woven fabrics. As a result, the yarns may be considered knittable yarns, in particular knittable, stretchable yarns.

The knit construction of the fabrics using the yarns is not necessarily limited by the present disclosure. For instance, various types of knit constructions as known in the art may be utilized to form a fabric and/or resulting article utilizing the fibers/filaments and yarns as disclosed herein. As just certain examples, the knit construction may be one as disclosed in U.S. Pat. Nos. 9,689,092, 10,370,782, or US Patent Publication No. 2021/0254244, all of which are hereby incorporated in their entirety.

In one particular embodiment, the knit construction may be a circular knit construction. Without intending to be limited, articles formed from circular knit constructed fabrics may be more comfortable than other knit constructions partially due to the ability of the fabric to stretch, at least in selective areas. For instance, when a force is applied, the circular knit fabric may stretch slightly due to the compression and/or elongation that may occur among the stitches/loops of the fabric and then may recover.

Generally, knitting is a process for constructing a fabric by interlocking a series of loops (bights) of one or more strands organized in wales and courses. In general, knitting includes warp knitting and weft knitting. In warp knitting, a plurality of strands runs lengthwise in the fabric to make all the loops. In weft knitting, one continuous strand runs crosswise in the fabric, making all the loops in one course. Weft knitting includes fabrics formed on both circular knitting and flat knitting machines. With circular knitting machines, the fabric is produced in the form of a tube, with the strands running continuously around the fabric. With a flat knitting machine, the fabric is produced in flat form, the threads alternating back and forth across the fabric. The resulting textile includes an interior side (the technical back) and an exterior side (the technical face), each layer being formed of the same or varying strands and/or stitches. By way of example, the knit structure may be a single knit/jersey fabric, a double knit/jersey fabric, and/or a plated fabric (with yarns of different properties are disposed on the face and back).

The textile may be formed via weft knitting, where one continuous thread runs crosswise in the fabric making all of the loops in one course. Preferably, the weft knitted textile is formed via circular knitting, in which the textile is produced in the form of a tube, with the threads running continuously around the textile.

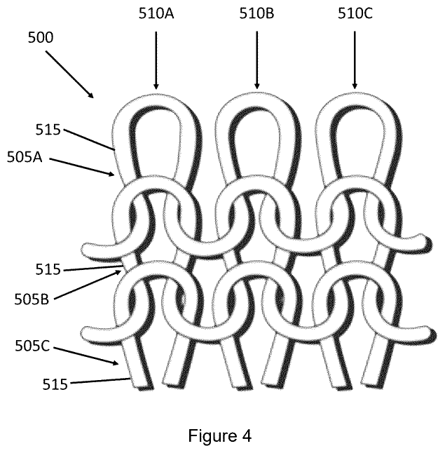

Referring to FIG. 4, the textile may possess a knit structure 500 organized in courses 505A, 505B, 505C and wales 510A, 510B, 510C, each course being formed by a strand. The term “strand” includes a plurality of fiber(s)/filament(s) in a form suitable for knitting, weaving, or otherwise intertwining to form a textile fabric. For example, such fibers/filaments may be in the form of one or more yarns. In particular, if multiple yarns are utilized, such yarns may be brought together (e.g., double stranding) for forming the fabric. In an embodiment, the knit structure 500 includes a first strand 515. Such first strand 515 may include a first fiber of a fiber-forming material and a second fiber of a thermoplastic elastomer as disclosed herein. The strand 515 forms a plurality of courses 505 within the knit structure 500 and, in particular, a plurality of successive courses 505. In the knit structure, in one embodiment, at least one strand 515 may be formed from a first fiber of a fiber-forming material and a second fiber of a thermoplastic elastomer as disclosed herein. In one embodiment, other strands 515 may be formed from other materials than disclosed herein. In one embodiment, all of the strands within the knit structure may be formed from a first fiber and a second fiber as disclosed herein.

In other words, a strand may include a plurality of fibers. Such plurality of fibers may include a first fiber of a fiber-forming material and a second fiber of a thermoplastic elastomer as disclosed herein. In one embodiment, the strand may include a first yarn and a second yarn, wherein such yarns are brought together to form the fabric and/or fabric section. The first yarn may include a plurality of fibers including a first fiber formed from a fiber-forming material. The second yarn may include a second fiber formed from a thermoplastic elastomer. In one embodiment, the second yarn may also include a plurality of fibers including a second fiber formed from a thermoplastic elastomer. Accordingly, such respective fibers may be present in the fabric and respective fabric sections in various configurations.

Particularly, with respect to one embodiment of a fabric structure as disclosed herein, a loop may include a plurality of fibers. Such plurality of fibers may include a first fiber of a fiber-forming material and a second fiber of a thermoplastic elastomer as disclosed herein. In one embodiment, the loop may include a first yarn and a second yarn, wherein such yarns are brought together to form the fabric and/or fabric section. The first yarn may include a plurality of fibers including a first fiber formed from a fiber-forming material. The second yarn may include a second fiber formed from a thermoplastic elastomer. In one embodiment, the second yarn may also include a plurality of fibers including a second fiber formed from a thermoplastic elastomer. Accordingly, such respective fibers may be present in the fabric and respective fabric sections in various configurations.

As indicated, other types of strands and yarns may also be utilized. For instance, in the knit structure, in one embodiment, at least one strand may be another strand typically used in the art. For instance, such strand may be formed of a synthetic material. Such strand may be formed from an elastic. These may include strands of anidex, elastoester, bi-constituent filament rubber, and combinations thereof. Alternatively, in one embodiment, such strand may be an inelastic strand, typically not formed of an elastomeric material. These strands may include natural fibers including cellulosic fibers (e.g., cotton, bamboo) and protein fibers (e.g., wool, silk, and soybean) as well as synthetic fibers including polyester fibers (poly(ethylene terephthalate) fibers and poly(trimethylene terephthalate) fibers), polycaprolactam fibers, poly(hexamethylene adipamide) fibers, acrylic fibers, acetate fibers, rayon fibers, nylon fibers and combinations thereof.

The knit structure may also be a double-knit structure. Generally, such a structure can be formed on a knit machine having two needle beds. These machines may include, but are not limited to, a V-bed flat knit machine, a double jersey circular knit machine, and the like. The double-knit structure may provide a technical face that is knit on one of the needle beds, and a technical back that is knit on the remaining needle bed of the knit machine. When looking at the technical face and the technical back of the double-knit structure, both sides may look like the technical face of a single-knit jersey and contain face loops or weft knit loops. In certain embodiments, linking yarns may be used to connect the technical face and the technical back of the double-knit structure where the linking yarns pass back and forth between the two different needle beds. The double-knit structure may be formed on a machine where the needles in one bed are directly opposite the needles in the other bed (known as interlock gaiting). The double-knit structure may also be formed on a machine where the needles in one bed are directly opposite spaces in the other bed (known as rib gaiting).

In the above double-knit structure, the technical face may form an outer-facing surface of a resulting article and the technical back may form an inner-facing surface of a resulting article. The technical face of the structure may be formed from a first yarn. In one embodiment, the first yarn may be a yarn as disclosed herein including a first fiber and a second fiber. Alternatively, the first yarn may be any type of yarn generally utilized in the art, such as a non-elastic yarn or an elastic yarn, for example a yarn as disclosed herein. The non-elastic yarn may include polyamide yarns, cotton yarns, cellulosic yarns, and/or polyester yarns. The technical back of the structure may be formed from a second yarn and optionally the first yarn. The second yarn may be a yarn as disclosed herein including a first fiber and a second fiber. Alternatively, the second yarn may be an elastic yarn, such as a yarn disclosed herein. However, at least one of the first yarn and the second yarn may be a yarn as disclosed herein including a first fiber and a second fiber.

Regardless of the knit structure, the fabric may include a thermoplastic elastomer-based fiber in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The thermoplastic elastomer-based yarn may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

Related, the thermoplastic elastomer may be present in the fabric in a particular amount. For instance, it may be present in an amount of 2 wt. % or more, such as 4 wt. % or more, such as 6 wt. % or more, such as 8 wt. % or more, such as 10 wt. % or more, such as 15 wt. % or more, such as 20 wt. % or more, such as 25 wt. % or more, such as 30 wt. % or more, such as 35 wt. % or more, such as 40 wt. % or more, such as 45 wt. % or more, such as 50 wt. % or more, such as 55 wt. % or more, such as 60 wt. % or more, such as 65 wt. % or more, such as 70 wt. % or more, such as 75 wt. % or more, such as 80 wt. % or more, such as 85 wt. % or more, such as 90 wt. % or more, such as 95 wt. % or more based on the weight of the fabric. The thermoplastic elastomer may be present in an amount of 100 wt. % or less, such as 98 wt. % or less, such as 95 wt. % or less, such as 90 wt. % or less, such as 85 wt. % or less, such as 80 wt. % or less, such as 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less, such as 30 wt. % or less, such as 25 wt. % or less, such as 20 wt. % or less, such as 15 wt. % or less, such as 10 wt. % or less based on the weight of the fabric.

The knit structure, regardless of whether in accordance with a structure as described herein or otherwise, can be incorporated into a resulting article. In particular, the fabric formed from the knit structure can be incorporated into a resulting article. Accordingly, the resulting article may comprise or be formed from the fabric. The article may not necessarily be limited by the present disclosure.

Further, as indicated herein, the fabric of the present disclosure, either prior to forming a resulting article or after forming the article, includes a first fabric section and a second fabric section, each having different mechanical properties. Such difference may be obtained by subjecting the second fabric section to a subsequent process after formation, particularly wherein the second fabric section is subjected to a temperature greater than room temperature. In particular, the second fabric section is subjected to a temperature equal to or greater than the melting temperature of the thermoplastic elastomer. In one embodiment, the second fabric section is subjected to a temperature greater than the melting temperature of the thermoplastic elastomer. By subjecting, it may be understood that this may cover various methods of providing such increased temperature. For instance, it may include contacting the second fabric section with a heating element or component having a particular temperature as described below. In other words, it may include placing the second fabric section in contact with a surface having a particular temperature as described below. Meanwhile, in one embodiment, the first fabric section may not be subjected to such temperature. To the extent the first fabric section is subjected to an elevated temperature greater than room temperature, such temperature may be less than the melting temperature of the thermoplastic elastomer.

In this regard, the second fabric section may be subjected to a temperature of about 100° C. or more, such as about 110° C. or more, such as about 130° C. or more, such as about 150° C. or more, such as about 170° C. or more, such as about 190° C. or more, such as about 200° C. or more, such as about 220° C. or more, such as about 240° C. or more. The temperature may be about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less.

In one embodiment, the second fabric section may also be subjected to a pressure greater than atmospheric pressure. By subjecting, in one embodiment, the pressure may be applied to the particular area of the second fabric section. For instance, such application may be via compacting or pressing using means generally known in the art. For instance, these may include a heated (or platen) press, hand iron, calendaring, as well as other means known in the art. In this regard, such subjection and application may be via contact means in one embodiment. In another embodiment, such subjection and application may also be via non-contact means.

By subjecting or exposing the second fabric section to such temperature and optionally such pressure, in certain embodiments to such temperature and pressure, the second fabric section may then exhibit different properties, particularly mechanical properties, than the first fabric section as described herein. In particular, without intending to be limited by theory, such exposure may soften and/or melt the thermoplastic elastomer of the fiber and yarn in the fabric, particularly the second fabric section. After removing the heat and pressure, if present, the thermoplastic elastomer of the yarn in the fabric may then again solidify. However, due to melting, the thermoplastic elastomer utilized in forming the second fiber within the second fabric section may melt and thereby at least partially coat the first fiber within the second fabric section. However, such first fiber may still remain intact in an unmolten state and may extend to the first fabric section. However, in the first fabric section, the second fiber may also remain intact in an unmolten state.

Furthermore, as indicated herein, the first fiber of the first yarn is present in the second fabric section and the first fabric section. Accordingly, the second fiber from the thermoplastic elastomer may have softened and/or melted and/or fused in the second fabric section while it may not have softened, melted, and/or fused in the first fabric section. In addition, the first fiber of the fiber-forming material may also be continuous such that it is present in the first fabric section and the second fabric section. Also, in one embodiment, such application of heat and/or pressure may not be conducted in the first fabric section, particularly heat at a temperature equal to or greater than the melting temperature of the thermoplastic elastomer.

Such application of heat and/or pressure may be for 5 seconds or more, such as 10 seconds or more, such as 15 seconds or more, such as 20 seconds or more, such as 25 seconds or more, such as 30 seconds or more, such as 35 seconds or more, such as 40 seconds or more, such as 50 seconds or more, such as 60 seconds or more, such as 70 seconds or more, such as 80 seconds or more, such as 90 seconds or more, such as 100 seconds or more, such as 120 seconds or more, such as 140 seconds or more, such as 160 seconds or more, such as 180 seconds or more. The subjecting/application may be for 300 seconds or less, such as 360 seconds or less, such as 320 seconds or less, such as 280 seconds or less, such as 240 seconds or less, such as 200 seconds or less, such as 160 seconds or less, such as 140 seconds or less, such as 120 seconds or less, such as 100 seconds or less, such as 80 seconds or less, such as 60 seconds or less, such as 40 seconds or less, such as 20 seconds or less.

Further, such application of heat and/or pressure and formation of second fabric sections may be continuous or discontinuous. For instance, such second fabric sections may be formed at different areas or portions of the fabric. In this regard, a resulting fabric and article may include more than one second fabric section. Accordingly, such formation of second fabric sections may be intentional to provide desired properties in selective areas.

Also, it should be understood that such aforementioned process may be conducted on a fabric prior to formation of a resulting article, such as an apparel or garment. After conducting such aforementioned process, the resulting article may be formed from the fabric having the multiple fabric sections. In another embodiment, such aforementioned process may be conducted on a fabric after formation of the resulting article, such as an apparel or garment. In this regard, the resulting article may comprise and be formed from the fabric including having the multiple fabric sections.

As indicated herein, the present inventor has discovered that such melting and subsequent solidification, albeit in a different form, provides the second fabric section with different properties. In essence, such process can allow for selective control of properties within a fabric and resulting article. In addition, as mentioned herein, such process can allow for such selective control within a continuous fabric and thus not require knitting, sewing, gluing, etc. of two fabrics in order to obtain such difference in properties in a resulting fabric and article.

Accordingly, the fabric and process as disclosed herein provides flexibility. For instance, there is flexibility in the process of forming such fabric and article having the different properties in selective areas. In addition, the process allows for selective control of such properties within desired sections of a fabric and resulting article.

As indicated herein, the fabric may be utilized in a number of articles. Primarily, the fabric may be utilized in articles such as apparel and garments. The apparel or garment may include, but is not limited to, short or long-sleeved shirts, tank tops, undershirts, jackets, coats, pants, trousers, shorts, socks, undergarments, nylons/leggings, dresses, skirts, hats/headgear, outerwear, etc. Other articles of apparel or garments include, but are not limited to, sleepwear, swimwear, compression garments, denim, stretchable clothing, including athletic wear, etc. One particular embodiment may include undergarments, such as shape wear. Another particular embodiment may include active wear.

### TEST METHODS

Tensile Properties: The tensile properties, such as tensile modulus and elongation, of a fabric or fabric section may be determined in accordance with modified ASTM D4964-96 (2020) at a temperature of about 23° C. Regarding the apparatus for conducting the test, Option A under the clamping assembly was utilized. The tensile testing machine was utilized with a gage length of about 2 inches. For this test, ten specimens were tested, and the average was recorded.

### EXAMPLES

### Example 1

In this example, the fabric samples tested were formed of polyethylene terephthalate yarn (150 d) in an amount of 84 wt. % and thermoplastic copolyester elastomer yarn (40 denier) in an amount of 16 wt. %. The thermoplastic copolyester elastomer had a melting temperature of 193° C. Each sample was exposed to three different conditions: heat at 165° C. (Sample 1); heat at 202° C. without pressure (Sample 2); and pressed at 210° C. (Sample 3). The basis weight of each sample was approximately: 173 g/m² for base knit fabric as made without heat; Sample 2—109 g/m²; and Sample 3—191 g/m².

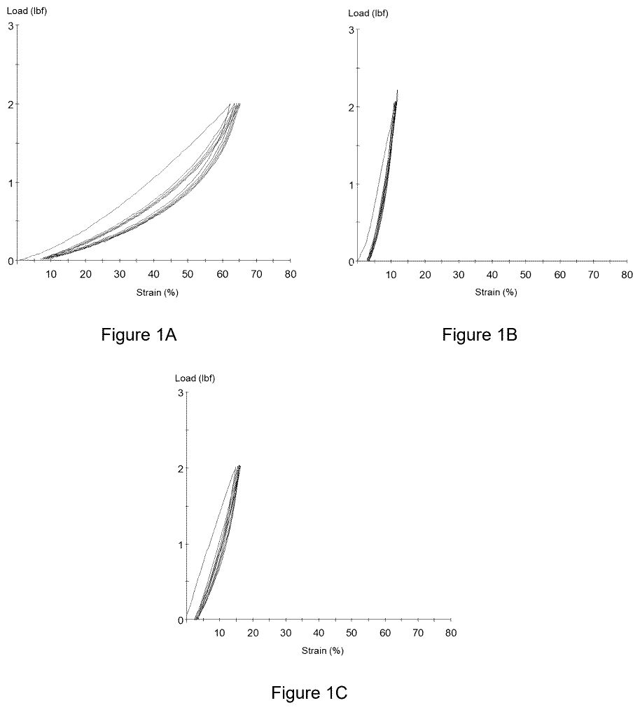

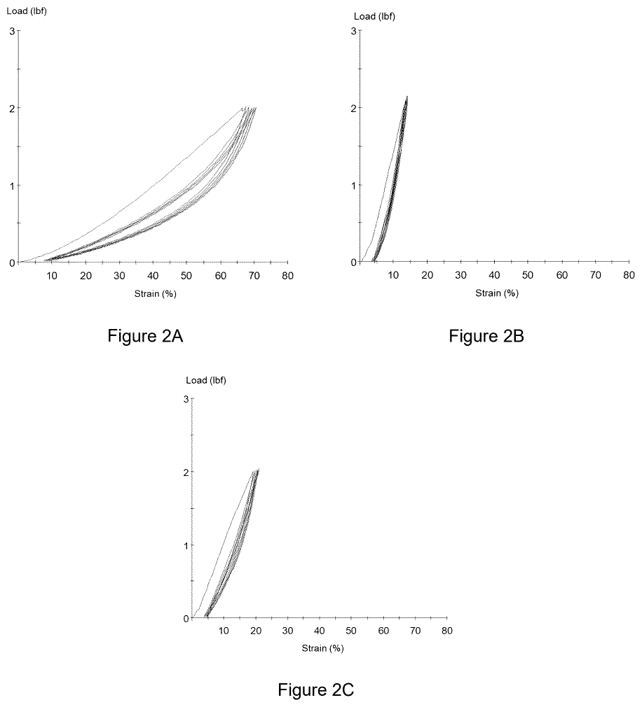

Furthermore, cyclic testing of the fabrics was conducted using a 2-inch wide by 12-inch length fabric, nominal 5-inch gauge loaded at 4 lb, and 5 cycles. The results are illustrated in FIGS. 1A-1C for Samples 1-3, respectively, in the length (or machine) direction and FIGS. 2A-2C for Samples 1-3, respectively, in the weft (or cross-machine) direction. As illustrated, after cyclic testing of Samples 2 and 3, the samples were generally able to retain their properties and shape.

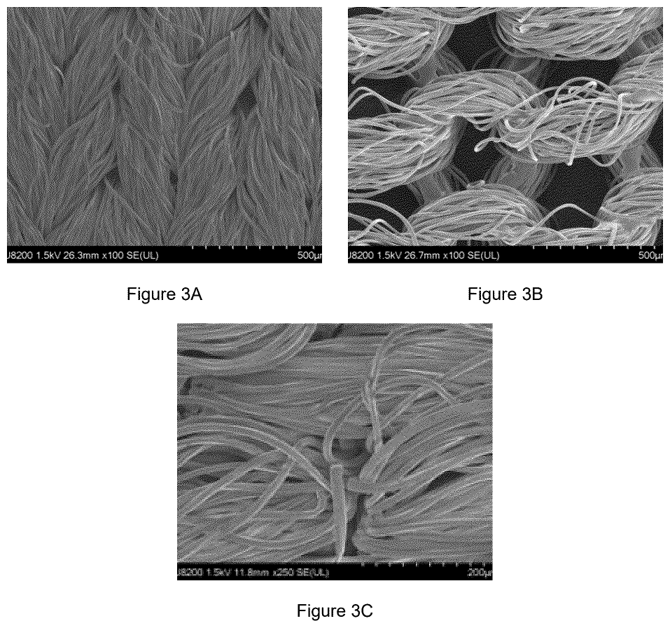

In addition, it was observed that Samples 2 and 3 exhibited a higher tensile modulus and bending stiffness. Further, Sample 2 exhibited a higher air permeability while Sample 3 exhibited a lower air permeability. Without intending to be limited, it is believed that such properties are realized due to melting of the thermoplastic copolyester elastomer and allowing the polyethylene terephthalate yarns to fully extend. For instance, the thermoplastic copolyester elastomer may not be present in fiber form and may appear on the surface of the polyethylene terephthalate yarn/filament. In addition, with the application of pressure for Sample 3, the polyethylene terephthalate yarns/filaments appeared to “consolidate.” The yarns were analyzed under scanning electron microscopy with the images provided in FIGS. 3A-3C for Samples 1-3, respectively.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

What is claimed is:

1. A continuous thermoplastic elastomer-based fabric comprising:
a first fabric section comprising a plurality of fibers comprising a first fiber comprising a fiber-forming material and a second fiber comprising a thermoplastic elastomer wherein the fiber-forming material has a melting temperature or a degradation temperature higher than a melting temperature of the thermoplastic elastomer, and
a second fabric section comprising the first fiber extending from the first fabric section wherein the first fiber is at least partially coated with the thermoplastic elastomer present in the second fabric section,
wherein the second fabric section has a higher tensile modulus than the first fabric section.

2. The fabric of claim 1, wherein the thermoplastic elastomer comprises a thermoplastic copolyester elastomer comprising hard segments and soft segments.

3. The fabric of claim 2, wherein the hard segments are derived from at least one aromatic dicarboxylic acid and/or a diester thereof and at least one diol containing from 2 to 15 carbon atoms.

4. The fabric of claim 3, wherein the aromatic dicarboxylic acid includes terephthalic acid, isophthalic acid, or a combination thereof.

5. The fabric of claim 3, wherein the diol includes ethylene glycol, 1,4 butanediol, 1,3-propane diol, or a combination thereof.

6. The fabric of claim 2, wherein the soft segments are derived from at least one aromatic dicarboxylic acid and/or a diester thereof and at least one poly(alkylene oxide) glycol.

7. The fabric of claim 6, wherein the aromatic dicarboxylic acid includes terephthalic acid, isophthalic acid, or a combination thereof.

8. The fabric of claim 6, wherein the poly(alkylene oxide) glycol includes poly(tetramethylene oxide) glycol, poly(trimethylene oxide) glycol, poly(propylene oxide) glycol, poly(ethylene oxide) glycol, poly(hexamethylene oxide) glycol, or a combination thereof.

9. The fabric of claim 2, wherein the hard segments constitute from about 20 wt. % or more to about 70 wt. % or less of the thermoplastic copolyester elastomer and the soft segments constitute from about 30 wt. % or more to about 80 wt. % or less of the thermoplastic copolyester elastomer.

10. The fabric of claim 2, wherein the thermoplastic copolyester elastomer comprises a thermoplastic copolyetherester elastomer prepared from monomers comprising (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof.

11. The fabric of claim 2, wherein the thermoplastic copolyester elastomer is a thermoplastic copolyetherester elastomer.

12. The fabric of claim 2, wherein the thermoplastic copolyester elastomer exhibits a Shore D hardness of about 60 or less, as determined in accordance with ISO 868:2003 (test time of 15 seconds) at a temperature of about 23° C.

13. The fabric of claim 1, wherein a ratio of the tensile modulus of the first fabric section to the tensile modulus of the second fabric section is less than 1.

14. The fabric of claim 1, wherein a ratio of the tensile modulus of the first fabric section to the tensile modulus of the second fabric section is from 0.1-0.5.

15. The fabric of claim 1, wherein a fabric weight of the second fabric section is less than a fabric weight of the first fabric section.

16. The fabric of claim 1, wherein the plurality of fibers comprises a first yarn comprising the first fiber and a second yarn comprising the second fiber.

17. The fabric of claim 1, wherein the plurality of fibers comprises a first yarn comprising the first fiber and the second fiber.

18. The fabric of claim 1, wherein the fabric is a knit fabric.

19. The fabric of claim 1, wherein the fabric is a woven fabric.

20. A method of making a continuous thermoplastic elastomer-based fabric, the method comprising:
providing a fabric comprising
a first fabric section comprising a plurality of fibers comprising a first fiber comprising a fiber-forming material and a second fiber comprising a thermoplastic elastomer wherein the fiber-forming material has a melting temperature or a degradation temperature higher than a melting temperature of the thermoplastic elastomer, and
a second fabric section comprising the first fiber extending from the first fabric section and the second fiber extending from the first fabric section, and
subjecting the second fabric section to a temperature equal to or greater than the melting temperature of the thermoplastic elastomer.
